(19) United States
(12) Patent Application Publication
(10) Pub. No.: US 2025/0233660 A1
(43) Pub. Date: Jul. 17, 2025

(54) Satellite Tracking Device And Satellite Optical Communication Device With The Same

(71) Applicant: Spacebeam Inc., Chungcheongbuk-Do (KR)

(72) Inventors: Won Seok KANG, Chungcheongbuk-do (KR); Yong Sun PARK, Chungcheongbuk-do (KR); Jung Hoon KIM, Chungcheongbuk-do (KR); Sang Hoon OH, Chungcheongbuk-do (KR); Tae Woo KIM, Chungcheongbuk-do (KR)

(21) Appl. No.: 19/024,069

(22) Filed: Jan. 16, 2025

(30) Foreign Application Priority Data
Jan. 17, 2024 (KR) 10-2024-0007097

(51) Int. Cl. H04B 10/118; G01S 7/481; G01S 17/06

(52) U.S. Cl. CPC H04B 10/118; G01S 7/481; G01S 17/06

(57) ABSTRACT

A satellite tracking device and a satellite optical communication device with the same.

### CROSS REFERENCE TO RELATED APPLICATION

This application claims priority from Korean Patent Application No. 10-2024-0007097, filed on Jan. 17, 2024, which is hereby incorporated by reference for all purposes as if fully set forth herein.

### TECHNICAL FIELD

An embodiment of the present disclosure relates to a satellite tracking device and a satellite optical communication device with the same. More particularly, embodiments of the present disclosure relate to a satellite tracking device which includes a satellite tracking module with an auxiliary telescope, a telescope mount, and a first image processing unit, and an optical communication receiving module with a main telescope, a beam correction unit, and a second image processing unit, and corrects satellite tracking errors of the telescope mount based on the first image processing result and controls the beam correction unit based on the second image processing result, and a satellite optical communication device with the satellite tracking device.

### BACKGROUND

Recently, there are being developed various services using artificial satellites (hereinafter referred to as “satellites”) for military, observation, and communication.

For this purpose, communication technology is needed to transmit and receive information collected and processed by satellites to ground devices.

In general, wireless communication using radio waves may be used for communication between satellites and ground stations, but wireless radio communication has limitations in communication speed and data transmission rate, so optical communication technology using lasers has recently been used between satellites and ground stations.

Meanwhile, spatial resolution and visit cycle are very important for an earth observation service using satellites.

Generally, geostationary orbit satellites may constantly observe specific locations on Earth, but it is difficult to increase the resolution since they observe from a long distance of about 36,000 km.

In addition, low-orbit satellites can observe the Earth with a high resolution of several tens of cm at an altitude of about 500 km, but a revisit cycle for a specific location on the Earth is relatively long, from several hours to a day.

Therefore, for various Earth observation services, there is widely used a method of placing a large number of ultra-small satellites with low development and launch costs in low earth orbit (LEO) and receiving images with appropriate resolution at a fast cycle.

Recently, as the quality of Earth observation services using low earth orbit satellites has improved, the amount of data required to be received on the ground has increased rapidly.

Therefore, there is utilized a laser optical communication technology capable of ultra-high-speed communication at the level of several Gbps.

In order to implement laser optical communication technology in space, the attitude control technology of the satellite is important to satisfy the high directivity of optical communication, but there is also important the ability of the optical communication ground station to receiving the laser on the ground to precisely track the satellite at high speed.

Specifically, it is required for the ground station to accurately direct and track low earth orbit satellites moving at speeds exceeding 1 degree per second with an accuracy of less than 0.01 degree.

Therefore, for optical communication with a satellite, a technology is needed for an optical communication receiving device located on the ground to precisely and stably track the target satellite.

Therefore, this disclosure proposes a satellite precision tracking technology capable of precisely and stably receiving laser signals from a low earth orbit satellite using two optical telescopes.

### SUMMARY

In this background, an aspect of the embodiments of the present disclosure is to provide a satellite tracking device capable of precisely tracking a target satellite for optical communications.

The other aspect of the embodiments of the present disclosure is to provide a satellite tracking device capable of improving the stability and accuracy of satellite tracking by separating the control of the telescope mount and the control of the beam correction device using two telescopes.

Another aspect of the embodiments of the present disclosure is to provide a satellite tracking device capable of precisely tracking a satellite by independently performing a first correction for controlling the telescope mount and a second correction for controlling the beam direction to an optical communication receiving device using two optical telescopes and two image processing units, and an optical communication device using the satellite tracking device.

Another object of the embodiments of the present disclosure is to provide an optical communication device including an optical communication module including a main telescope, an image processing unit, a beam correction unit, and a laser receiving device, and a satellite tracking module including an auxiliary telescope, an image processing unit, a telescope mount, and a mount correction unit.

In accordance with an aspect of the present disclosure, there may be provided a satellite tracking device including a main telescope for aiming at a satellite transmitting an optical signal for optical communication, an auxiliary telescope arranged on one side of the main telescope, a telescope mount supporting the main telescope and the auxiliary telescope and controlling a pointing direction of the main telescope and the auxiliary telescope, a first image processing unit for processing a first image acquired through the auxiliary telescope, a second image processing unit for processing a second image acquired through the main telescope, an optical unit for relaying or transmitting the optical signal received from the main telescope to the second image processing unit and an optical communication receiving device for optical communication, and a correction unit for performing a first correction for correcting a satellite tracking error of the telescope mount by controlling the telescope mount based on a result of processing the first image, and a second correction for correcting an optical path of an optical signal transmitted toward the optical communication receiving device by controlling the optical unit based on a result of processing the second image.

The optical unit may include a beam correction unit for controlling a first direction of the optical signal received from the main telescope, and a beam splitter for splitting the optical signal controlled by the beam correction unit into the second image processing unit and the optical communication receiving device.

The correction unit may record second position information of the optical communication receiving device in the second image, and obtain first position information of the optical communication receiving device in the first image using the second position information.

In addition, the correction unit may perform the first correction for correcting the satellite tracking error of the telescope mount based on a first error between the first position information and the position information of a target satellite to be tracked.

In addition, the correction unit may perform the second correction to guide the optical signal to the optical communication receiving device by controlling the beam correction unit based on a second error between the second position information and the position information of the target satellite.

In this case, a period for performing the first correction may be longer than a period for performing the second correction, and the correction unit may independently perform the first correction and the second correction.

In accordance with an aspect of the present disclosure, there may be provided a satellite optical communication device including an optical communication receiving module including a main telescope for aiming at a satellite transmitting an optical signal for optical communication, a second image processing unit for processing a second image acquired through the main telescope, an optical unit for relaying an optical signal received from the main telescope, and a laser receiving device for performing optical communication by receiving and processing the optical signal, and a satellite tracking module including an auxiliary telescope arranged on one side of the main telescope, a telescope mount for supporting the main telescope and the auxiliary telescope and controlling a satellite-oriented directions of the main telescope and the auxiliary telescope, and a first image processing unit for processing a first image acquired through the auxiliary telescope.

The optical communication device may further include a correction unit configured to perform a first correction to correct a satellite tracking error of the telescope mount by controlling the telescope mount based on a processing result of the first image, and a second correction to correct an optical path of an optical signal transmitted toward the laser receiving device by controlling the optical unit based on a processing result of the second image.

According to the embodiments of the present disclosure, it is possible to provide a satellite tracking device capable of precisely tracking a target satellite for optical communication.

In addition, according to the satellite tracking device according to the embodiments of the present disclosure, it is possible to improve the stability and accuracy of satellite tracking by separating the control of the telescope mount and the control of the beam correction device using two telescopes.

In addition, according to the embodiments of the present disclosure, it is possible to provide a satellite tracking device and an optical communication device capable of precisely tracking a satellite by independently performing the first correction for controlling the telescope mount and the second correction for controlling the beam direction to the optical communication receiving device using two optical telescopes and two image processing units.

In addition, according to one embodiment of the present disclosure, it is possible to provide an optical communication device including an optical communication module including a main telescope, an image processing unit, a beam correction unit and a laser receiving device, and a satellite tracking module including an auxiliary telescope, an image processing unit, a telescope mount and a mount correction unit.

### BRIEF DESCRIPTION OF THE DRAWINGS

FIG. 1 illustrates an example of a configuration of an optical communication receiving device installed in a ground station for satellite optical communication.

FIG. 2 illustrates an example of a configuration of a satellite tracking device according to an embodiment of the present disclosure.

FIG. 3 illustrates an example of a configuration of a telescope mount according to an embodiment of the present disclosure.

FIG. 4 illustrates a process of performing first and second corrections in a satellite tracking device according to an embodiment of the present disclosure.

FIG. 5 illustrates an example of a configuration using a first image and a second image to control a telescope mount and a beam correction unit in a satellite tracking device according to an embodiment of the present disclosure.

FIG. 6 illustrates an example of a method of performing first and second corrections by controlling a telescope mount and a beam correction unit using the first image and the second image in an embodiment of the present disclosure.

FIG. 7 illustrates a configuration diagram of a satellite optical communication device according to an embodiment of the present disclosure.

FIG. 8 illustrates an example of a schematic configuration of a satellite optical communication system using a satellite optical communication device according to an embodiment of the present disclosure.

FIG. 9 illustrates an example of a hardware configuration of a correction unit included in a satellite tracking device or a satellite optical communication device according to an embodiment of the present disclosure.

### DETAILED DESCRIPTION

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the present disclosure, detailed descriptions of well-known functions and components incorporated herein will be omitted when it is determined that the description may make the subject matter in some embodiments of the present disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements etc., but is used merely to distinguish the corresponding element from other elements.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that may be caused by various factors (e.g., process factors, internal or external impact, noise, etc.) even when a relevant description is not specified. Further, the term “may” fully encompasses all the meanings of the term “can”.

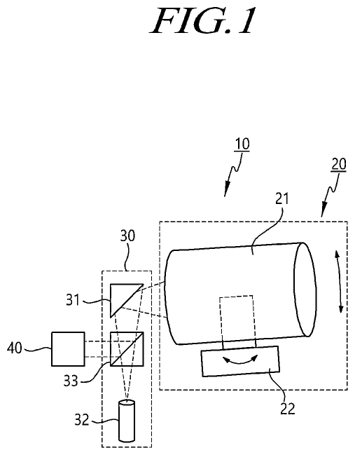

FIG. 1 illustrates an example of a configuration of an optical communication receiving device installed in a ground station for satellite optical communication.

In general, a satellite tracking and optical signal receiving method for satellite optical communication may be configured as follows.
(i) The satellite trajectory may be calculated over time by using the Two-Line Element Set (TLE) information, which is satellite orbit information.
(ii) The telescope mount may be controlled according to the satellite trajectory calculated over time.
(iii) The target position may be identified using the telescope field of view and beam correction may be performed simultaneously.

The following problems may occur in this control method.
(i) TLE information is abbreviated orbital information, and there may be a certain error (about 0.1 degree or more) compared to the precise prediction of the satellite trajectory.
(ii) The response speed and control precision of the telescope mount may vary depending on the manufacturer or specification.
(iii) The larger the telescope aperture, the narrower the telescope field of view (about 0.1 degree), which may cause a difficulty in detecting the target object and satellite.

Therefore, in the satellite tracking method for general satellite optical communications, the TLE calculation error may be larger than the narrow field of view of the telescope for receiving the optical signal (i.e., laser). Therefore, if the error accumulates and the satellite position goes out of the field of view of the telescope, there may not be able to perform the satellite tracking.

To overcome this problem, there may be used a device capable of processing an image acquired from a telescope and performing a telescope mount correction and a beam correction for satellite tracking, as shown in FIG. 1.

Referring to FIG. 1, an optical communication device 10 for satellite optical communication may be a device for receiving an optical signal such as a laser transmitted from an optical communication transmitter installed on a satellite, and may include a satellite tracking device 20, an optical signal receiving device 30, and an image processing device 40 for processing an image to control the optical communication receiving device.

More specifically, the satellite tracking device 20 may include a telescope 21 which initially receives light or optical signal from a satellite, and a telescope mount 22 for supporting the telescope and adjusting the direction of the telescope.

The optical signal receiving device 30 may include a beam correction device 31 capable of controlling the direction of propagation of an optical signal received and collected from a telescope, and an optical receiver 32 which finally receives the optical signal.

The image processing device 40 may process the image of the optical signal received from the telescope in order to control the direction of the telescope mount 22 and the beam correction device 31 so that the light from the satellite is accurately delivered to the optical receiver 32.

In addition, the optical signal receiving device 30 may further include an optical splitter 33 which splits the light reflected from the beam correction device 31 into the optical receiver 32 and the image processing device 40.

In an optical communication device 10 such as FIG. 1, it is necessary to perform mount correction to control the telescope mount 22 so that the telescope is oriented toward the satellite transmitting the light.

In addition, it is necessary to control the beam correction device 31 controlling the beam direction so that the light received/collected from the telescope accurately proceeds to the optical receiver 32. In this way, the control of the beam correction device 31 to correct the direction of propagation of the optical signal may be referred to as a beam correction.

To this end, the optical communication device 10 such as FIG. 1 may acquire the satellite position error based on the image processing result in the image processing device 40, and may perform the mount correction by controlling the telescope mount based on the satellite position error.

In addition, beam correction may be further performed by controlling a fast-steering mirror (FSM) included in the telescope before the optical signal receiving step or before and after the mount correction step.

That is, the optical communication device 10 as shown in FIG. 1 may perform the mount correction and beam correction simultaneously or sequentially through processing the image acquired through the telescope.

In the optical communication device 10 as shown in FIG. 1, the mount correction and beam correction may be performed simultaneously or sequentially, and each of the two corrections may affect the other correction during the process.

Therefore, it may be difficult to implement an accurate satellite tracking function since the two correction processes conflict or affect each other.

In one embodiment of the present disclosure, in order to overcome the above problem, the first correction for controlling the telescope mount and the second correction for controlling the beam direction to the optical communication receiving device may be independently performed by using two optical telescopes and two image processing units, thereby providing a satellite tracking device and an optical communication device capable of precisely tracking a satellite.

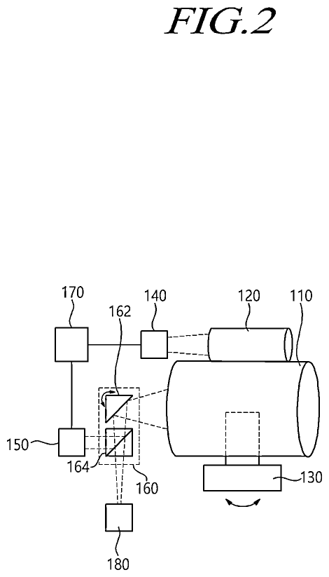

FIG. 2 illustrates an example of a configuration of a satellite tracking device according to an embodiment of the present disclosure.

A satellite tracking device according to one embodiment of the present disclosure may include two telescopes, a telescope mount, two image processing units, and a correction unit which independently performs mount correction and beam correction based on the image processing results.

More specifically, referring to FIG. 2, a satellite tracking device 100 according to one embodiment of the present disclosure may include a telescope unit including a main telescope 110 and an auxiliary telescope 120, a telescope mount 130 which supports the main telescope and the auxiliary telescope and controls the orientations of the main telescope and the auxiliary telescope, a first image processing unit 140 which processes a first image acquired through the auxiliary telescope 120, a second image processing unit 150 which processes a second image acquired through the main telescope 110, an optical unit 160, and a correction unit 170.

The main telescope 110 may be a large-diameter optical telescope aimed at a satellite transmitting an optical signal for optical communication.

The main telescope may be an optical telescope device for stably receiving a laser signal transmitted from a satellite.

Specifically, the main telescope may further include an optical telescope having a relatively long focal length, an imaging device, a beam splitter, a fast-steering mirror (FSM), a beam expander, and the like.

It is necessary to control the orientation of the main telescope so as for a laser to be stably received by the optical fiber included in the optical communication receiver by recognizing and compensating for the change in the position of the fine laser beam.

The main telescope 110 may be a refractive telescope or a reflective telescope including a large-diameter objective lens or reflector directed toward the target, but is not limited thereto.

In addition, an auxiliary telescope 120 may be arranged on one side of the main telescope.

The auxiliary telescope 120 may be an optical device for compensating for satellite tracking errors through a separate imaging device.

The auxiliary telescope 120 may further include an optical telescope with a relatively short focal length and an infrared camera.

The auxiliary telescope 120 may be used to secure a wide observation field of view by taking into account the error of the satellite trajectory when using TLE information, and may be used to compensate for the orientation and tracking errors of the telescope mount (i.e., the first correction) by using the image captured through the auxiliary telescope 120.

The auxiliary telescope 120 may have the same orientation as the main telescope 110, and may have a lower magnification than the main telescope.

That is, the aperture or diameter of the objective lens or reflector of the auxiliary telescope 120 may be smaller than that of the main telescope 110, and the field of view (FOV) range of the auxiliary telescope 120 may be larger than that of the main telescope 110.

The telescope mount 130 may be an astronomical observation device in which two telescopes for satellite tracking and receiving optical signals (i.e., laser signals) are mounted together on one axis and the two telescopes are precisely controlled simultaneously by a motor.

The telescope mount 130 may perform a tracking function for precisely directing or tracking a location on the celestial sphere using an altitude/azimuth coordinate system or an hour angle and declination coordinate system.

For this purpose, the telescope mount 130 may be controlled to support the main telescope 110 and the auxiliary telescope 120 at the same time, and to change the orientation of the main telescope 110 and the auxiliary telescope 120.

The telescope mount 130 may be configured as a mechanical device having two driving shafts, but is not limited thereto.

The two driving shafts of the telescope mount 130 may include a first mount driving shaft Am and the second mount driving shaft Bm, respectively, and the two driving shafts may be used as reference axes for a first correction for correcting the satellite tracking error of the telescope mount 130 based on the processing result of the first image as described below.

The telescope mount 130 may be one of an equatorial mount or an altazimuth mount, but is not limited thereto.

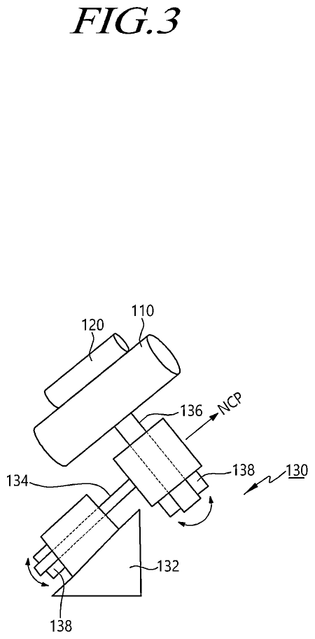

An example of the detailed configuration of the telescope mount 130 is described in more detail below based on FIG. 3.

The first image processing unit 140 may process the first image acquired through the auxiliary telescope 120.

The first image processing unit 140 may perform a function of processing the first image acquired through the auxiliary telescope 120 to perform the first correction for correcting satellite tracking errors of the telescope mount by controlling the telescope mount.

The second image processing unit 150 may process the second image acquired through the main telescope.

The second image processing unit 150 may process the second image acquired through the main telescope to perform the second correction for correcting the optical path of the optical signal transmitted toward the optical communication receiving device by controlling the optical unit 160.

The optical unit 160 may be an optical device which transmits an optical signal received from the main telescope 110 to the second image processing unit 150 and an optical communication receiving device 180 for optical communication.

As an example, the optical unit 160 may include a beam correction unit 162 which controls a first direction of an optical signal received from the main telescope 110, and a beam splitter 164 which splits the optical signal controlled by the beam correction unit 162 into the second image processing unit 150 and the optical communication receiving device 180.

The beam correction unit 162 may include a mirror and a mechanical control device for controlling the direction of the mirror.

The beam correction unit 162 may include, but is not limited to, a mechanical device having two driving shafts.

The two driving shafts of the beam correction unit 162 may include a first mirror driving shaft Ab and a second mirror driving shaft Bb, respectively, and the two driving shaft may be used as a reference axes for the second correction to correct the optical path of the optical signal transmitted toward the optical communication receiving device 180 by controlling the beam correction unit 162 of the optical unit based on the processing result of the second image as described below.

The correction unit 170 may control the telescope mount 130 and the beam correction unit 162 of the optical unit 160 based on the image processing results of the first image processing unit 140 and the second image processing unit 150.

More specifically, the correction unit 170 may perform a first correction to correct the satellite tracking error of the telescope mount by controlling the telescope mount 130 based on the processing results of the first image and the second image.

At the same time, the correction unit 170 may perform a second correction to correct the optical path of the optical signal transmitted toward the optical communication receiving device 180 by controlling the beam correction unit 162 of the optical unit based on the processing results of the first and second images.

That is, the first image processing unit 140 and the second image processing unit 150 may be controlled by the correction unit 170 to process the first and second images acquired from the auxiliary telescope 120 and the main telescope 110, respectively.

In addition, the correction unit 170 may perform the first and second corrections to correct the direction of the telescope and the direction of travel of the optical signal incident on the main telescope by controlling the telescope mount 130 and the beam correction unit 162 based on the processing results of the first and second images.

Specifically, the correction unit 170 may control the first image processing unit 140 and the second image processing unit 150 to record the second position information of the optical communication receiving device 180 in the second image acquired from the main telescope 110, and may obtain the first position information of the optical communication receiving device 180 in the first image acquired from the auxiliary telescope 120 using the second position information.

Thereafter, the correction unit 170 may perform the first correction to correct the satellite tracking error of the telescope by controlling the telescope mount 130 based on a first error between the first position information and the position information of the target satellite.

In addition, the correction unit 170 may perform a second correction to accurately guide the optical signal incident from the main telescope to the optical communication receiving device 180 by controlling the beam correction unit 162 of the optical unit 160 based on a second error between the second position information and the position information of the target satellite.

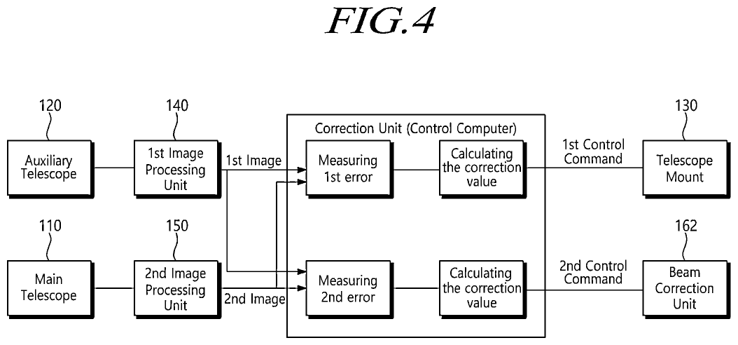

The specific configuration of the image processing of the first/second image processing unit and the first/second correction performed by the correction unit 170 based on the result will be described in more detail below based on FIGS. 4 to 6.

Meanwhile, a period of performing the first correction performed by the correction unit 170 may be longer than a period of performing the second correction.

In addition, the correction unit 170 may independently perform the first correction and the second correction.

That is, the correction unit 170 may perform the first correction and the second correction simultaneously or sequentially, but may independently perform the first correction and the second correction so that the result of one correction does not affect the other correction.

The definitions or descriptions of terms or components used in this specification are as follows.

A communication applied to the satellite tracking device and the satellite optical communication device according to the present disclosure may be Free-Space Optical Communication (FSOC).

FSOC may refer to a technology for wirelessly transmitting and receiving an optical communication laser signal transmitted through an optical fiber to free space by applying an optical communication technology using an optical fiber. In this case, the laser signal may be a shortwave infrared wavelength signal such as 1064 nm, 1310 nm, or 1550 nm, which enables to minimize the absorption and scattering effect of the atmosphere and is safe for the body.

The transmitter used in the satellite tracking device and satellite optical communication device according to the present disclosure may be a laser communication terminal (LCT).

The LCT may refer to a satellite payload or terminal device mounted on a satellite to transmit a laser signal containing information from the satellite to the ground. In order to transmit a weak laser signal over a long distance, an optical fiber amplifier may be used or the size of the beam may be minimized. Generally, a laser signal may be transmitted using an optical fiber.

Satellite tracking information used for the satellite tracking in a satellite tracking device and a satellite optical communication device according to the present disclosure may be defined as two-line element set (TLE) information.

The TLE information may be a standardized information format which summarizes and describes the orbital information of a satellite in two lines. Each satellite has unique TLE information and requires continuous updates.

A trajectory of the satellite may be estimated in advance by combining the latest TLE with the position information of the observation site.

In the case of low earth orbit satellites, in a satellite trajectory (i.e., predicted satellite position information) calculated through TLE information, the actual position of the satellite may have an error of up to tens of kilometers per day, so it is necessary to reduce the error through the first correction (i.e., telescope mount correction) according to the present disclosure.

FIG. 3 illustrates an example of a configuration of a telescope mount according to an embodiment of the present disclosure.

Referring to FIG. 3, the telescope mount 130 according to one embodiment of the present disclosure may be a declination mount.

The telescope mount supporting the telescope may be equipped with a tracking function for tracking a celestial body or satellite, which is an observation target moving on the celestial sphere, by the telescope.

The telescope mount may be one of an equatorial mount, or an altazimuth mount, and the telescope mount 130 according to one embodiment of the present disclosure will be described assuming that it is an equatorial mount.

An equatorial mount can rotate the telescope in the right ascension direction and the declination direction, and can track a celestial body or satellite by rotating the telescope, which is fixed to a specific direction of the celestial sphere, such as the north celestial pole, in the right ascension direction at the rotation speed of the celestial body or satellite (360°/1 sidereal day=360°/23 hours 56 minutes 4 seconds, or 360°/1 solar day=360°/24 hours for the Sun).

The equatorial mount may include a German Equatorial Mount (GEM), an Open Fork Mount, an English Mount or Yoke Mount, a Horseshoe Mount, etc.

FIG. 3 illustrates a configuration of telescope mount 130 using a German equatorial type as an example.

Referring to FIG. 3, the telescope mount 130 may include a support 132, a right ascension axis 134 extending parallel to a polar axis from the support 132 toward the north celestial pole or the south celestial pole of a celestial body, a declination axis 136 perpendicularly connected to the ascension axis 134 at one end of the right ascension axis 134, and a mount driving unit 138 for rotating the ascension axis and the declination axis.

The main telescope 110 may be attached to one side of the declination axis 136, and an auxiliary telescope 120 may be arranged on the other side of the main telescope 110.

In addition, the other side of the declination axis 136 may further include a counter weight of a specific weight to balance the weight of the main telescope and the auxiliary telescope.

The mount driving unit 138 may be a mechanical device including one or more motors, gears, and bearings, and may adjust the satellite-oriented direction of the main telescope 110 and the auxiliary telescope by rotating the right ascension axis 134 and the declination axis 136.

That is, the main telescope 110 and the auxiliary telescope 120 may be directed to a specific celestial body on the celestial sphere or a target satellite for satellite optical communication according to the rotation of the right ascension axis 134 and the declination axis 136 under the control of the mount driving unit 138.

In the case of the telescope mount 130 having configuration as shown in FIG. 3, the correction unit 170 according to the present embodiment may control the mount driving unit 138 of the telescope mount 130 based on the processing results of the first image and the second image.

Specifically, the correction unit 170 may perform the first correction to correct satellite tracking errors of the main telescope 110 and the auxiliary telescope 120 by controlling the mount driving unit 138.

As an example, the correction unit 170 may calculate a satellite trajectory over time using Two-Line Element Set (TLE) information, which is satellite orbit information, and may control the mount driving unit of the telescope mount according to the calculated satellite trajectory so as for the telescope to direct toward the target satellite for the communication.

In this case, depending on the error of the TLE information or the response speed or control precision of the telescope mount, the telescope may not accurately aim at the target satellite only with the control through the TLE.

That is, if only the tracking function for general satellite tracking using the TLE information is performed, there may be occurred the satellite tracking error of the main telescope 110 and the auxiliary telescope 120.

Therefore, in one embodiment of the present disclosure, the correction unit 170 may control the mount driving unit 138 of the telescope mount 130 based on the processing results of the first image acquired from the auxiliary telescope 120 and the second image acquired through the main telescope 110, and thereby perform the first correction to correct the satellite tracking errors of the main telescope 110 and the auxiliary telescope 120.

FIG. 4 illustrates a process of performing first and second corrections in a satellite tracking device according to an embodiment of the present disclosure.

Referring to FIG. 4, the correction unit 170 of the satellite tracking device according to the present embodiment may be implemented in the form of a control computer, and the control computer may be linked to the first image processing unit 140, the second image processing unit 150, the mount driving unit 138 of the telescope mount 130, and the beam correction unit 162 among the optical units.

The first image formed by the light incident on the auxiliary telescope 120 may be input to the first image processing unit 140, and the first image processing result processed by the first image processing unit 140 may be input to the correction unit 170, which is the control computer.

The second image formed by the light incident on the main telescope 110 may be input to the second image processing unit 150, and the second image processing result processed by the second image processing unit 150 may be input to the correction unit 170, which is the control computer.

In some cases, the first/second image processing unit may not separately process the first/second image acquired from the telescope, but may instead transmit the first/second image to the correction unit 170, and the correction unit 170 may process the first/second image.

In this case, the first image processing result and the second image processing result may be at least one of the position coordinate information of the optical communication receiving device and the position coordinate information of the target satellite within the first image and the second image, as described below.

In this case, the optical communication receiving device 190 may be a laser receiving device, but is not limited thereto.

The correction unit 170 may calculate a first error, which is the difference between the telescope's pointing direction and the target satellite direction, using the first image processing result and the second image processing result, and may generate a first control command to control the telescope mount 130 based on the first error, and transmit the first control command to the telescope mount driving unit 138 of the telescope mount 130.

The telescope mount driving unit 138 of the telescope mount 130 may be driven according to the first control command to make the directions of the main telescope 110 and the auxiliary telescope 120 face the target satellite, thereby performing the first correction.

At the same time or sequentially, the correction unit 170 may calculate a second error, which is the difference between the direction of travel of the beam passing through the optical unit and the direction of reception of the optical communication receiving device, using the first image processing result and the second image processing result, and may generate a second control command to control the beam correction unit 162 based on the second error and transmit the second control command to the beam correction unit 162.

The beam correction unit 162 of the optical unit 160 may be driven according to the second control command to make the direction of travel of the beam faces the direction of reception of the optical communication receiving device, thereby performing the second correction.

The first correction and the second correction by the correction unit 170 may be performed independently.

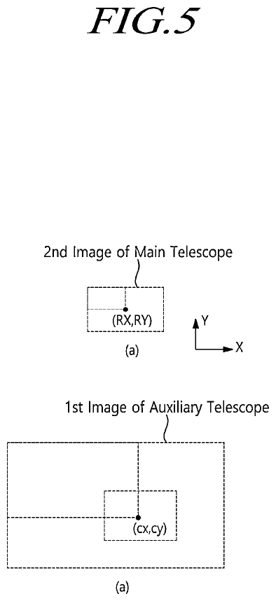

FIG. 5 illustrates an example of a configuration using a first image and a second image to control a telescope mount and a beam correction unit in a satellite tracking device according to an embodiment of the present disclosure.

The (a) of FIG. 5 illustrates an example of a second image with a narrow field of view (FOV) acquired from the main telescope 110, and (b) of FIG. 5 (b) illustrates an example of a first image with a wide field of view acquired from the auxiliary telescope 120.

As described above, the correction unit 170 may control the first image processing unit 140 and the second image processing unit 150 to record the second position information of the optical communication receiving device 180 in the second image acquired from the main telescope 110, and may acquire the first position information of the optical communication receiving device 180 in the first image acquired from the auxiliary telescope 120 using the second position information.

FIG. 5 is a drawing for explaining an example of such a configuration.

Referring to FIG. 5, the position of the optical communication receiving device may be recorded as the (RX, RY) coordinate in the second image acquired from the main telescope 110.

The same object may be photographed and compared with the main telescope 110 and the auxiliary telescope 120, and the position coordinate (cx, cy) of the optical communication receiving device may be acquired in the first image acquired from the auxiliary telescope 120.

The difference between the position coordinate (cx, cy) of the optical communication receiving device and the position coordinate of the target satellite in the first image acquired from the auxiliary telescope 120 may be used to calculate the first error, which is the tracking error of the telescope mount, and a first control command may be generated to correct the tracking error (i.e., the first correction).

Since the telescope mount 130 may take tens to hundreds of ms (milliseconds) to perform the first correction in response to the first control command, the correction unit 170 may correct large variations and continuous position errors at long time intervals.

The second error for controlling the beam correction unit 162 may be calculated by using the difference between the position coordinates (RX, RY) of the optical communication receiving device in the second image acquired from the main telescope 110 and the position coordinates of the target satellite in the second image, and a second control command may be generated to correct the second error (i.e., the second correction).

The beam correction unit 162 may be controlled based on the second control command to precisely guide the optical communication signal, i.e., the laser signal, received from the main telescope to the optical communication receiving device.

Since the control of the beam correction unit 162 may be performed quickly in the order of several ms (milliseconds), it is possible to correct fluctuations with very short control time intervals and small changes.

The nature of the correction target and error in the first and second correction processes are different from each other. Therefore, since the input and output of information in the first and second correction processes may be performed independently, thereby effectively reducing the two tracking errors.

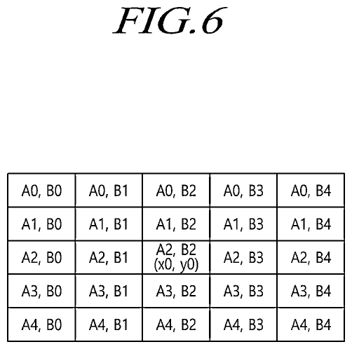

FIG. 6 illustrates an example of a method of performing first and second corrections by controlling a telescope mount and a beam correction unit using the first image and the second image in an embodiment of the present disclosure.

As described above, the correction unit 170 of the satellite tracking device according to one embodiment of the present disclosure may perform the first correction to correct the satellite tracking error of the telescope by controlling the telescope mount 130 based on the first error between the first position information and the position information of the tracking target satellite.

In addition, the correction unit 170 may perform a second correction to accurately guide an optical signal incident from the main telescope to the optical communication receiving device 180 by controlling the beam correction unit 162 of the optical unit 160 based on the second error between the second position information and the position information of the target satellite to be tracked.

FIG. 6 illustrates an example of a configuration for calculating the first error and the second error used to perform the first correction and the second correction.

As described above, the telescope mount 130 and the beam correction unit 162 may each include two driving shafts, and each driving shaft may have A and B as position values or position coordinates.

That is, the position coordinate of a first driving shaft of the telescope mount 130 or the beam correction unit 162 may be defined as A, and the position coordinate of a second driving shaft may be defined as B.

Referring to FIG. 6, an explicitly distinguishable bright celestial light source may be selected and positioned at the center (x0, y0) of the first image or the second image, and there may be obtained the respective driving shaft position values A(x0, y0) and B(x0, y0) corresponding to the center.

A specific number N is set, and an N×N axis position array may be created around the current driving shaft position.

FIG. 6 illustrates an example of a case where N is 5, in which case A(x0, y0)=A2, B(x0, y0)=B2.

The telescope mount or beam correction unit may be controlled to move each driving shaft position, and the movement value (dx, dy) of the bright light source in the first image or the second image may be measured.

For example, if the driving shaft position is moved from (A2, B2) to (A0, B0) and the position of the target (i.e., the bright light source) changes from (x0, y0) to (x′, y′), there may be expressed as dA=(A0−A2), dB=(B0−B2), dx=(x′−x0), dy=(y′−y0).

Since the change in the position of the driving shaft (dA, dB) and the corresponding change in the position of the bright light source in the image (dx, dy) may have a linear relationship in a narrow area, and there may be expressed by the following Equation 1.

In addition, if N is 2 or more, it is possible to estimate the matrix M through regression analysis.

$$dx ( dA , dB ) = M 00 \times dA + M 01 \times dB + zx \qquad [ Equation 1 ]$$

$$dx ( dA , dB ) = M 10 \times dA + M 11 \times dB + zy$$

$$( \begin{matrix}dx - zx \\ dy - zy\end{matrix} ) = ( \begin{matrix}M 00 & M 01 \\ M 10 & M 11\end{matrix} ) ( \begin{matrix}dA \\ dB\end{matrix} ) = M ( \begin{matrix}dA \\ dB\end{matrix} )$$

Here, the inverse matrix C of the matrix M may be calculated, so that it is possible to calculate the change in position (dx, dy) of the tracking target in the image which has deviated from the position of the optical communication receiving device. In addition, it is possible to calculate the change in each driving shaft position (dA, dB) for moving to the position of the optical communication receiving device through the Equation 2 below.

$$( \begin{matrix}dA \\ dB\end{matrix} ) = ( \begin{matrix}C 00 & C 01 \\ C 10 & C 11\end{matrix} ) ( \begin{matrix}dx - zx \\ dy - zy\end{matrix} ) = C ( \begin{matrix}dx - zx \\ dy - zy\end{matrix} ) \qquad [ Equation 2 ]$$

The amount of change (dA, dB) of each driving shaft position calculated in the above manner may be the values of the first error and the second error for the first correction or the second correction according to one embodiment of the present disclosure.

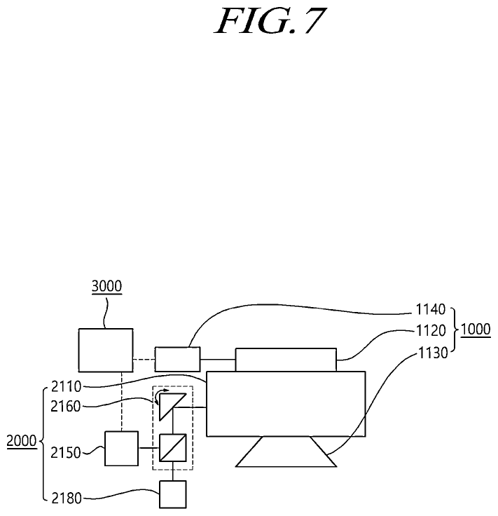

FIG. 7 illustrates a configuration diagram of a satellite optical communication device according to an embodiment of the present disclosure.

Referring to FIG. 7, a satellite optical communication device according to one embodiment of the present disclosure may include a satellite tracking module 1000 and an optical communication receiving module 2000.

The satellite tracking module 1000 may include an auxiliary telescope 1120 arranged on one side of a main telescope 2110, a telescope mount 1130 which supports the main telescope 2110 and the auxiliary telescope 1120 and controls the satellite-oriented directions of the main telescope and the auxiliary telescope, and a first image processing unit 1140 which processes a first image acquired through the auxiliary telescope.

The optical communication receiving module 2000 may include a main telescope 2110 for aiming at a satellite transmitting an optical signal for optical communication, a second image processing unit 2150 for processing a second image acquired through the main telescope, an optical unit 2160 for transmitting an optical signal received from the main telescope, and a laser receiving device 2180 for receiving and processing the optical signal to perform optical communication.

The auxiliary telescope 1120, the telescope mount 1130, and the first image processing unit 1140 included in the satellite tracking module 1000 may include the same configuration as the auxiliary telescope 120, the telescope mount 130, and the first image processing unit 140 included in the satellite tracking device according to the embodiment disclosed in FIG. 2.

In addition, the main telescope 2110, the second image processing unit 2150, and the optical unit 2160 included in the optical communication receiving module 2000 may correspond to the main telescope 110, the second image processing unit 150, and the optical unit 160 included in the satellite tracking device according to the embodiment disclosed in FIG. 2, respectively.

Specifically, the optical unit 2160 may include a beam correction unit which controls a first direction of the laser signal received from the main telescope 2110, and a beam splitter which splits the optical signal controlled by the beam correction unit into the second image processing unit and the laser receiving unit.

In addition, the laser receiving device 2180 included in the optical communication receiving module 2000 may have the same configuration as the optical communication receiving device 180 in the embodiment disclosed in FIG. 2.

In addition, the satellite optical communication device according to one embodiment of the present disclosure may further include a correction unit 3000 which performs a first correction for correcting a satellite tracking error of the telescope mount by controlling the telescope mount based on the processing result of the first image, and a second correction for correcting an optical path of an optical signal transmitted toward the laser receiving device by controlling the optical unit based on the processing result of the second image.

The correction unit 3000 may perform the same function as the correction unit 170 included in the satellite tracking device according to the embodiment disclosed in FIG. 2.

Specifically, the correction unit 3000 included in the satellite optical communication device according to one embodiment of the present disclosure may record second position information of the laser receiving device 2180 in the second image acquired from the main telescope 2110, and may obtain first position information of the laser receiving device in the first image acquired from the auxiliary telescope using the second position information.

In addition, the correction unit 3000 may perform a first correction to correct the satellite tracking error by controlling the telescope mount 1130 based on the first error between the first position information and the position information of the satellite to be tracked.

In addition, the correction unit 3000 may perform a second correction to guide the laser signal received through the main telescope 2110 to the laser receiving device 2180 by controlling the beam correction unit of the optical unit 2160 based on the second error between the second position information and the position information of the target satellite.

In this case, the period for performing the first correction may be longer than the period for performing the second correction, and the first correction and the second correction may be performed independently.

According to the optical communication device such as FIG. 7, the first correction for controlling the telescope mount and the second correction for controlling the beam direction to the laser receiving device may be independently performed by using two optical telescopes and two image processing units, so that the satellite may be precisely tracked, thereby improving the performance of satellite optical communication.

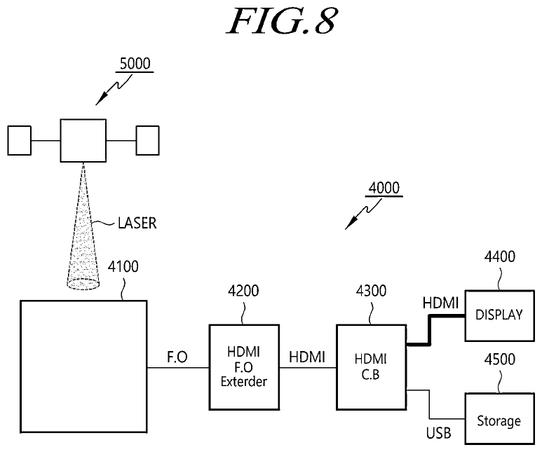

FIG. 8 illustrates an example of a schematic configuration of a satellite optical communication system using a satellite optical communication device according to an embodiment of the present disclosure.

The optical communication system to which an embodiment of the present disclosure is applied may include a satellite 5000 including an image capturing and transmitting device, and a satellite image receiving device 4000 installed in a ground station.

The satellite image receiving device 4000 may include an optical receiving device 4100 including a satellite tracking device or an optical communication device according to an embodiment of the present disclosure, an HDMI optical fiber extender 4200, an HDMI capture board 4300, and a display unit 4400 and a storage unit 4500 connected to the HDMI capture board 4300.

The optical receiving device 4100 may include a satellite tracking device disclosed in FIGS. 2 to 4. That is, the optical receiving device 4100 may include a satellite tracking device capable of precisely tracking a satellite by independently performing a first correction for controlling a telescope mount and a second correction for controlling a receiving beam direction using two optical telescopes and two image processing units.

Alternatively, the optical receiving device 4100 may include a satellite optical communication device disclosed in FIG. 7. That is, the optical receiving device 4100 may include a satellite tracking module including an auxiliary telescope, a telescope mount, and a first image processing unit, an optical communication receiving module 2160 including a main telescope, a second image processing unit and an optical unit, and a satellite optical communication device including a correction unit that independently performs a first correction for controlling a telescope mount and a second correction for controlling a receiving beam direction based on image processing results of the first/second image processing units.

The satellite image receiving device 4000 may include an HDMI optical fiber extender 4200 which receives an image received from an optical receiving device 4100 through an optical fiber and converts the image into an HDMI image signal.

The HDMI optical fiber extender 4200 may convert a UHD-class high-resolution (e.g., 3840×2160) HDMI signal output from an image device such as a PC, camera, or DVD device into a laser signal capable of 10 Gbps transmission and transmit the laser signal over a long distance. A Small Form-factor Pluggable (SFP) tool may be used to convert the HDMI signal into a laser signal.

In addition, the HDMI optical fiber extender 4200 may convert the transmitted high-resolution video laser signal back into an HDMI video signal via SFP and output the HDMI video signal to a display unit.

The HDMI capture board 4300 may receive a video signal from the HDMI optical fiber extender 4200 connected via HDMI, and then transmit the video signal to the display unit 4400 to output the video, or store the video data in a storage unit 4500.

The HDMI capture board 4300 may be a device which receives an HDMI video signal and transmits it to a connected computer device. Using this HDMI capture board 4300, a UHD-class high-resolution (e.g., 3840×2160) HDMI video signal may be stored or recorded as a video on a computer, or may be output directly to a display unit.

In this way, when using an HDMI optical fiber extender 4200 and an HDMI capture board 4300, even when the satellite image receiving device 4000 cannot properly track the satellite 5000 and cannot receive signals, there may provide the effect of quickly recovering image data through realignment due to the characteristics of the HDMI image signal.

In addition, although not shown, the satellite 5000 may include a satellite image transmitting device.

The satellite image transmitting device may capture a specific location on the ground as a video using a small high-resolution camera mounted on the satellite, and at the same time, convert the video signal into a laser signal using an HDMI optical fiber extender (i.e., transmitter), and then amplify the signal using an optical fiber amplifier and transmit the amplified signal to the ground.

To this end, the satellite image transmitting device included in the satellite may include a UHD-class video camera, an HDMI optical fiber extender, an optical fiber amplifier, a laser transmitter, etc.

A UHD-class video camera and an HDMI optical fiber extender may be connected via HDMI.

In addition, an HDMI optical fiber extender, an optical fiber amplifier, and a laser transmitter may be connected via optical fiber to transmit and receive video data.

According to a satellite optical communication system such as that of FIG. 8, it is possible to directly transmit high-resolution video taken from a micro satellite to the ground, and to be immediately received and confirmed by the ground station.

In addition, according to a satellite optical communication system such as FIG. 8, the free space optical communication technology capable of communication up to 10 Gbps may be applied to an Earth observation satellite service of a micro satellite, so it is possible to transmit the original data of a UHD-class high-resolution video (e.g., 3840×2160) captured from a micro satellite from space to the ground in real time without a separate storage device.

In addition, according to the satellite optical communication system such as FIG. 8, since the shooting and transmission of a high-resolution observation video are performed simultaneously from a micro satellite, the operational efficiency of the micro satellite can be maximized, and the real-time image of the Earth taken from the satellite may be confirmed right away on the ground.

In addition, the HDMI video signal transmitted from space may be received on the ground and checked right away, or the original data may be stored as is and used for various purposes in the future without loss.

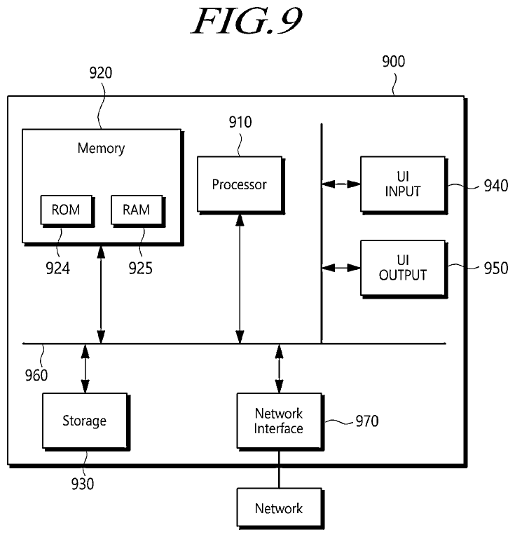

FIG. 9 illustrates an example of a hardware configuration of a correction unit included in a satellite tracking device or a satellite optical communication device according to an embodiment of the present disclosure.

The correction unit 170 and 3000 included in the satellite tracking device or satellite optical communication device according to the embodiments may be implemented as a specific hardware or software implemented within a computer system.

That is, the correction unit 170 and 3000 described above may be implemented as a computer device having hardware such as that of FIG. 9.

As shown in FIG. 9, a computer system 900, which is an implementation form of a correction unit 170 and 3000 included in a satellite tracking device or a satellite optical communication device according to the present embodiment, may include one or more elements of one or more processors 910, a memory 920, a storage 930, a user interface input unit 940, and a user interface output unit 950, and the elements may communicate with each other through a bus 960.

In addition, the computer system 900 may also include a network interface 970 for connecting to a network. The processor 910 may be a central processing unit (CPU) or a semiconductor device that executes processing instructions stored in the memory 920 and/or the storage 930. The memory 920 and the storage 930 may include various types of volatile/nonvolatile storage media. For example, the memory may include a read-only memory (ROM) 924 and a random access memory (RAM) 925.

In addition, in the computer system 900, there may be installed a software module for performing the function of a correction unit 170 and 3000 included in a satellite tracking device or satellite optical communication device according to the embodiments.

Specifically, a software module for performing first and second corrections to correct errors in the telescope's pointing direction and beam path by controlling the telescope mount and beam correction unit based on the processing results of the first image acquired from the auxiliary telescope and the second image acquired from the main telescope may be installed in the computer system 900.

The processor (CPU or MCU) 910 of the computer system 900 according to the present embodiment may execute the software module stored in the storage 930 or memory 920 to perform the corresponding function.

As described above, according to the embodiments of the present disclosure, it is possible to provide a satellite tracking device capable of precisely tracking a target satellite for optical communication.

In addition, according to the satellite tracking device according to the embodiments of the present disclosure, it is possible to improve the stability and accuracy of satellite tracking by separating the control of the telescope mount and the control of the beam correction device using two telescopes.

In addition, according to the embodiments of the present disclosure, the first correction for controlling the telescope mount and the second correction for controlling the beam direction to the optical communication receiving device may be independently performed by using two optical telescopes and two image processing units, so it is possible to provide e a satellite tracking device and an optical communication device capable of precisely tracking a satellite.

In addition, according to one embodiment of the present disclosure, it is possible to provide an optical communication device including an optical communication module including a main telescope, an image processing unit, a beam correction unit, and a laser receiving device, and a satellite tracking module including an auxiliary telescope, an image processing unit, a telescope mount, and a mount correction unit.

It should be noted that although all or some of the configurations or elements included in one or more of the embodiments described d above have been combined to constitute a single configuration or component or operated in combination, the present disclosure is not necessarily limited thereto. That is, within the scope of the object or spirit of the present disclosure, all or some of the configurations or elements included in the one or more of the embodiments may be combined to constitute one or more configurations or components or operated in such combined configuration(s) or component(s). Further, each of the configurations or elements included in one or more of the embodiments may be implemented by an independent hardware configuration; however, some or all of the configurations or elements may be selectively combined and implemented by one or more computer program(s) having one or more program module(s) that perform some or all functions from one or more combined hardware configuration(s). Codes or code segments constituting the computer program(s) may be easily produced by those skilled in the art. As the computer programs stored in computer-readable media are read and executed by a computer, embodiments of the present disclosure can be implemented. The media for storing computer programs may include, for example, a magnetic storing medium, an optical recording medium, and a carrier wave medium.

Further, unless otherwise specified herein, terms ‘include’, ‘comprise’, ‘constitute’, ‘have’, and the like described herein mean that one or more other configurations or elements may be further included in a corresponding configuration or element. Unless otherwise defined herein, all the terms used herein including technical and scientific terms have the same meaning as those understood by those skilled in the art. The terms generally used such as those defined in dictionaries should be construed as being the same as the meanings in the context of the related art and should not be construed as being ideal or excessively formal meanings, unless otherwise defined herein.

The above description has been presented to enable any person skilled in the art to make and use the technical idea of the present disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the present disclosure. The above description and the accompanying drawings provide an example of the technical idea of the present disclosure for illustrative purposes only. That is, the disclosed embodiments are intended to illustrate the scope of the technical idea of the present disclosure. Thus, the scope of the present disclosure is not limited to the embodiments shown, but is to be accorded the widest scope consistent with the claims. The scope of protection of the present disclosure should be construed based on the following claims, and all technical ideas within the scope of equivalents thereof should be construed as being included within the scope of the present disclosure.

What is claimed is:

1. A satellite tracking device comprising:
a main telescope for aiming at a satellite transmitting an optical signal for optical communication;
an auxiliary telescope arranged on one side of the main telescope;
a telescope mount supporting the main telescope and the auxiliary telescope and controlling a pointing direction of the main telescope and the auxiliary telescope;
a first image processing unit for processing a first image acquired through the auxiliary telescope;
a second image processing unit for processing a second image acquired through the main telescope;
an optical unit for relaying the optical signal received from the main telescope to the second image processing unit and an optical communication receiving device for optical communication; and
a correction unit for performing a first correction for correcting a satellite tracking error of the telescope mount by controlling the telescope mount based on a result of processing the first image, and a second correction for correcting an optical path of an optical signal transmitted toward the optical communication receiving device by controlling the optical unit based on a result of processing the second image.

2. The satellite tracking device of claim 1, wherein the optical unit comprises:
a beam correction unit for controlling a first direction of the optical signal received from the main telescope; and
a beam splitter for splitting the optical signal controlled by the beam correction unit into the second image processing unit and the optical communication receiving device.

3. The satellite tracking device of claim 2, wherein the correction unit records second position information of the optical communication receiving device in the second image, and obtains first position information of the optical communication receiving device in the first image using the second position information.

4. The satellite tracking device of claim 3, wherein the correction unit performs the first correction for correcting the satellite tracking error of the telescope mount based on a first error between the first position information and the position information of a target satellite to be tracked.

5. The satellite tracking device of claim 4, wherein the correction unit performs the second correction to guide the optical signal to the optical communication receiving device by controlling the beam correction unit based on a second error between the second position information and the position information of the target satellite.

6. The satellite tracking device of claim 1, wherein a period for performing the first correction is longer than a period for performing the second correction, and the correction unit independently performs the first correction and the second correction.

7. A satellite optical communication device comprising:
an optical communication receiving module including a main telescope for aiming at a satellite transmitting an optical signal for optical communication, a second image processing unit for processing a second image acquired through the main telescope, an optical unit for relaying an optical signal received from the main telescope, and a laser receiving device for performing optical communication by receiving and processing the optical signal; and
a satellite tracking module including an auxiliary telescope arranged on one side of the main telescope, a telescope mount for supporting the main telescope and the auxiliary telescope and controlling a satellite-oriented directions of the main telescope and the auxiliary telescope, and a first image processing unit for processing a first image acquired through the auxiliary telescope.

8. The satellite optical communication device of claim 7, further comprising a correction unit configured to perform a first correction to correct a satellite tracking error of the telescope mount by controlling the telescope mount based on a processing result of the first image, and a second correction to correct an optical path of an optical signal transmitted toward the laser receiving device by controlling the optical unit based on a processing result of the second image.

9. The satellite optical communication device of claim 8, wherein the optical unit includes:
a beam correction unit for controlling a first direction of the optical signal received from the main telescope; and
a beam splitter which splits the optical signal controlled by the beam correction unit into the second image processing unit and the laser receiving device.

10. The satellite optical communication device of claim 9, wherein the correction unit records second position information of the laser receiving device in the second image, and obtains first position information of the laser receiving device in the first image using the second position information.

11. The satellite optical communication device of claim 10, wherein the correction unit performs the first correction for correcting the satellite tracking error of the telescope mount based on a first error between the first position information and position information of a target satellite to be tracked.

12. The satellite optical communication device of claim 11, wherein the correction unit performs the second correction to guide the optical signal to the laser receiving device by controlling the beam correction unit based on a second error between the second position information and the position information of the target satellite.

13. The satellite optical communication device of claim 8, wherein a period for performing the first correction is longer than a period for performing the second correction, and the correction unit independently performs the first correction and the second correction.
